(19) United States
(12) Patent Application Publication
(10) Pub. No.: US 2010/0105441 A1
(43) Pub. Date: Apr. 29, 2010

(54) Display Size of Representations of Content

(76) Inventors: Chad Aron Voss, Seattle, WA (US); Michael J. Kruzeniski, Seattle, WA (US); Michael K. Henderlight, Sammamish, WA (US); Grant Gardner, Seattle, WA (US); Joseph P. McLaughlin, Seattle, WA (US)

Correspondence Address: SADLER, BREEN, MORASCH & COLBY, P.S., 422 W. RIVERSIDE AVE., SUITE 424, SPOKANE, WA, 99201, US

(21) Appl. No.: 12/469,480

(22) Filed: May 20, 2009

Related U.S. Application Data
(60) Provisional application No. 61/107,945, filed on Oct. 23, 2008.
(60) Provisional application No. 61/107,921, filed on Oct. 23, 2008.

(51) Int. Cl. H04B 1/38

(52) U.S. Cl. 455/566

(57) ABSTRACT

Techniques involving a display size of representations in a user interface are described. In one or more implementations, a mobile communications device assigns a display size to representations of a plurality of content based on metadata associated with the content that indicates when the content was captured. The assigned display size of a first representation is larger than the assigned display size of a second representation. The first and second representations are displayed concurrently in a user interface on the mobile communications device as having respective assigned display sizes.

### RELATED APPLICATIONS

This application claims priority under 35 U.S.C. Section 119(e) to U.S. Provisional Patent Applications Nos. 61/107,945, 61/107,935, and 61/107,921, each of which was filed on Oct. 23, 2008, the entire disclosures of which are hereby incorporated by reference.

### BACKGROUND

Mobile communication devices (e.g., wireless phones) have become an integral part of everyday life. However, the form factor employed by conventional mobile communications devices is typically limited to promote mobility of the mobile communications device.

For example, the mobile communications device may have a relatively limited amount of display area when compared to a conventional desktop computer, e.g., a PC. Therefore, conventional techniques used to interact with a desktop computer may be inefficient when employed by a mobile communications device.

### SUMMARY

Techniques involving a display size of representations in a user interface are described. In one or more implementations, a mobile communications device assigns a display size to representations of a plurality of content based on metadata associated with the content that indicates when the content was captured. The assigned display size of a first representation is larger than the assigned display size of a second representation. The first and second representations are displayed concurrently in a user interface on the mobile communications device as having respective assigned display sizes.

In one or more implementations, one or more computer-readable storage media include instructions that are executable by a computer to classify each of a plurality of content into a respective one of a plurality of groups based on metadata associated with the content. A display size is assigned to representations of each of the plurality of content based on the group. The display size assigned to a first representation of content classified to a first group is larger than the display size assigned to a second representation of content classified to a second group. The representations of the plurality of content are output in a user interface as having the assigned display size.

In one or more implementations, a mobile communications device includes a display device, an image capture device, and one or more modules. The one or more modules are configured to scale representations of images captured by the image capture device based on when the images were captured and output the scaled representations of the images on the display device such that at least three of the representations have different sizes, one to another.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of a mobile communications device in accordance with one or more embodiments of devices, features, and systems for mobile communications.

FIG. 2 is an illustration of a system in an example implementation in which the mobile communications device of FIG. 1 includes an image capture device and outputs a user interface having a plurality of representations of images.

FIG. 3 is an illustration of a system in which the user interface of FIG. 1 includes representations of contacts displayed using the display size representation techniques.

FIG. 4 is a flow diagram depicting a procedure in an example implementation in which representations are displayed as having a display size that is assigned according to when content that corresponds to the representations was captured.

FIG. 5 is a flow diagram depicting a procedure in an example implementation in which content is classified into groups that serve as a basis for assigning a display size to representations of the content.

FIG. 6 is a flow diagram depicting a procedure in an example implementation in which representations of images captured by a mobile communications device are scaled based on when the images were captured.

FIG. 7 illustrates various components of an example device that can be implemented in various embodiments as any type of a mobile device to implement embodiments of devices, features, and systems for mobile communications.

### DETAILED DESCRIPTION

### Overview

In order to support mobility of a mobile communications device, the device is typically configured with a limited amount of display area. Therefore, techniques used to interact with content on a conventional computer may be inefficient and frustrating when implemented on the mobile communications device. For example, representations of content (e.g., icons having thumbnails of images) are conventionally output on the conventional computer as having a matching size. Although this may be convenient when significant display resources are available (e.g., a monitor as typically encountered with a desktop PC), navigation through the representations to locate content of interest may be frustrating when using relatively limited display resources such as those typically utilized by a mobile communications device.

Techniques involving display sizes of representations of content are described. In an implementation, representations of content (e.g., images, contacts, and so on) are displayed in different sizes depending on metadata associated with the content. For example, images may be arranged in groups such as “Just Now,” “Earlier,” “Last Week,” “Last Month,” and so on according to when the images were taken. Each of the groups may be associated with a display size for representations in that group, such as first size of representations in the “Just Now” group and decreasing with each successive group. Therefore, more recent representations that have an increased likelihood of being of interest to a user are displayed in a size that corresponds to this likelihood, e.g., the representations having a relatively high likelihood have a larger display size when compared with representations having a relatively lower likelihood. A variety of other examples are also contemplated, further discussion of which may be found in relation to the following figures.

In the following discussion, a variety of example implementations of a mobile communications device (e.g., a wireless phone) are described. Additionally, a variety of different functionality that may be employed by the mobile communications device is described for each example, which may be implemented in that example as well as in other described examples. Accordingly, example implementations are illustrated of a few of a variety of contemplated implementations. Further, although a mobile communications device having one or more modules that are configured to provide telephone functionality are described, a variety of other mobile communications devices are also contemplated, such as personal digital assistants, mobile music players, dedicated messaging devices, portable game devices, netbooks, and other computers.

Example Implementations

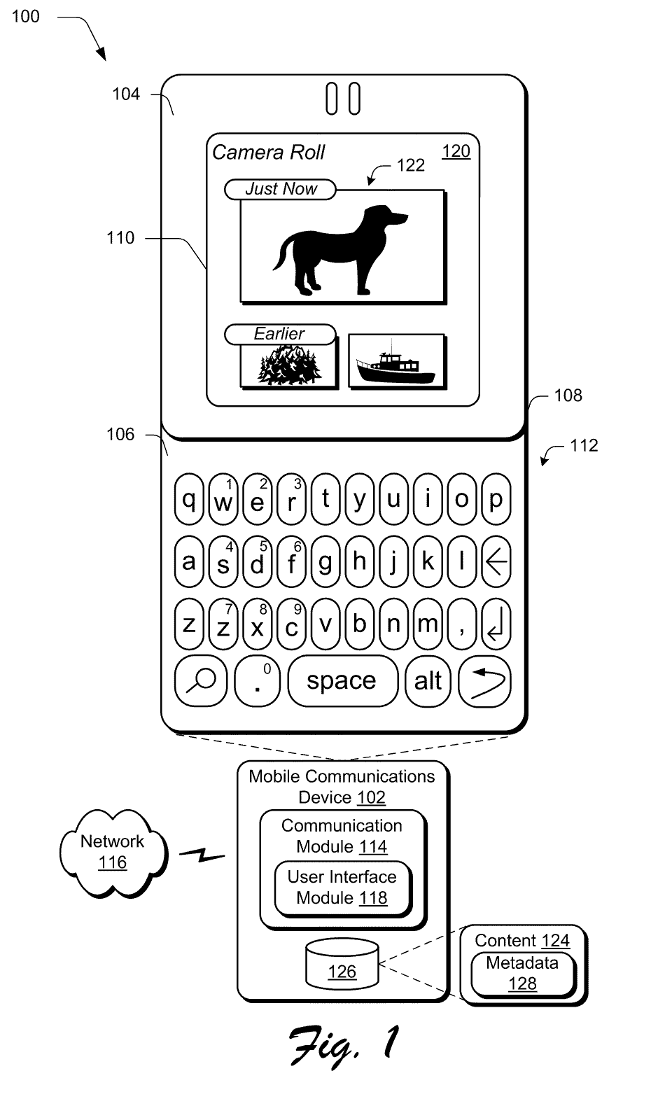

FIG. 1 is an illustration of an example implementation 100 of a mobile communications device 102 in accordance with one or more embodiments of devices, features, and systems for mobile communications. The mobile communications device 102 is operable to assume a plurality of configurations, examples of which include a configuration in which the mobile communications device 102 is “open” as illustrated in FIG. 1 and a configuration in which the mobile communications device 102 is “closed.”

For example, the mobile communications device 102 is further illustrated as including a first housing 104 and a second housing 106 that are connected via a slide 108 such that the first and second housings 104, 106 may move (e.g., slide) in relation to one another. Although sliding is described, it should be readily apparent that a variety of other movement techniques are also contemplated, e.g., a pivot, a hinge and so on. Indeed, in some implementations a “brick” configuration may also be used in which movement is not performed by the mobile communications device 102 to assume the “open” configuration.

The first housing 104 includes a display device 110 that may be used to output a variety of data, such as a caller identification (ID), representations of content (e.g., contacts) as illustrated, email, multimedia messages, Internet browsing, game play, music, video and so on. In an implementation, the display device 110 may also be configured to function as an input device by incorporating touchscreen functionality, e.g., through capacitive, surface acoustic wave, resistive, optical, strain gauge, dispersive signals, acoustic pulse, and other touchscreen functionality.

The second housing 106 is illustrated as including a keyboard 112 that may be used to provide inputs to the mobile communications device 102. Although the keyboard 112 is illustrated as a QWERTY keyboard, a variety of other examples are also contemplated, such as a keyboard that follows a traditional telephone keypad layout (e.g., a twelve key numeric pad found on basic telephones), keyboards configured for other languages (e.g., Cyrillic), and so on.

In the “open” configuration as illustrated in the example implementation 100 of FIG. 1, the first housing 104 is moved (e.g., slid) “away” from the second housing 106 using the slide 108. In this example configuration, at least a majority of the keys of the keyboard 112 (i.e., the physical keys) is exposed such that the exposed keys are available for use to provide inputs. As previously described, other implementations are also contemplated, such as a “clamshell” configuration, “brick” configuration, and so on.

The form factor employed by the mobile communications device 102 may be suitable to support a wide variety of features. For example, the keyboard 112 is illustrated as supporting a QWERTY configuration. This form factor may be particularly convenient to a user to utilize the previously described functionality of the mobile communications device 102, such as to compose texts, play games, check email, “surf” the Internet, provide status messages for a social network, and so on.

The mobile communications device 102 is also illustrated as including a communication module 114. The communication module 114 is representative of functionality of the mobile communications device 102 to communicate via a network 116. For example, the communication module 114 may include telephone functionality to make and receive telephone calls. The communication module 114 may also include a variety of other functionality, such as to form short message service (SMS) text messages, multimedia messaging service (MMS) messages, emails, status messages for a social network, and so on. A user, for instance, may input a status message for communication via the network 116 to a social network website. The social network website may then publish the status message to “friends” of the user, e.g., for receipt by the friends via a computer, respective mobile communications device, and so on. A variety of other examples are also contemplated, such as blogging, instant messaging, and so on.

The communication module 114 is also illustrated as including a user interface module 118. The user interface module 118 is representative of functionality of the mobile communications device 102 to generate, manage, and/or output a user interface 120 for display on the display device 110. A variety of different techniques may be employed to generate the user interface 120.

For example, the user interface module 118 may configure the user interface 120 to display representations 122 of content 124 in the user interface 120 to have different display sizes, one to another. In the illustrated environment 100, the content 124 is stored in storage 126, but may also be accessed via the network 116. The content 124 has metadata 128 associated with it that describes the content 124, such as a temporal indication (e.g., when the content 124 was captured), how often the content 124 was displayed in the user interface 120, and so on. Thus, the metadata 128 may be leveraged by the user interface module 118 to compute a likelihood that the content 124 will be of interest to a user.

This likelihood may then be used to assign a display size to the representations 122 in the user interface such that representations 122 that have an increased likelihood of being of interest to the user of the mobile communications device 102 have a larger display size than those that have a lesser likelihood. As shown in the user interface 120 of FIG. 1, for instance, a representation of an image that was captured “Just Now” has a larger display size than representations that were captured “Earlier.” Thus, location and selection of content may be performed with increased efficiency, both on a mobile communications device 102 that has a relatively limited amount of display area on the display device 110 as well as other computers, e.g., desktop PCs. The display size techniques may be leveraged in a variety of different ways for a variety of different content, an example of which may be found in relation to the following figure.

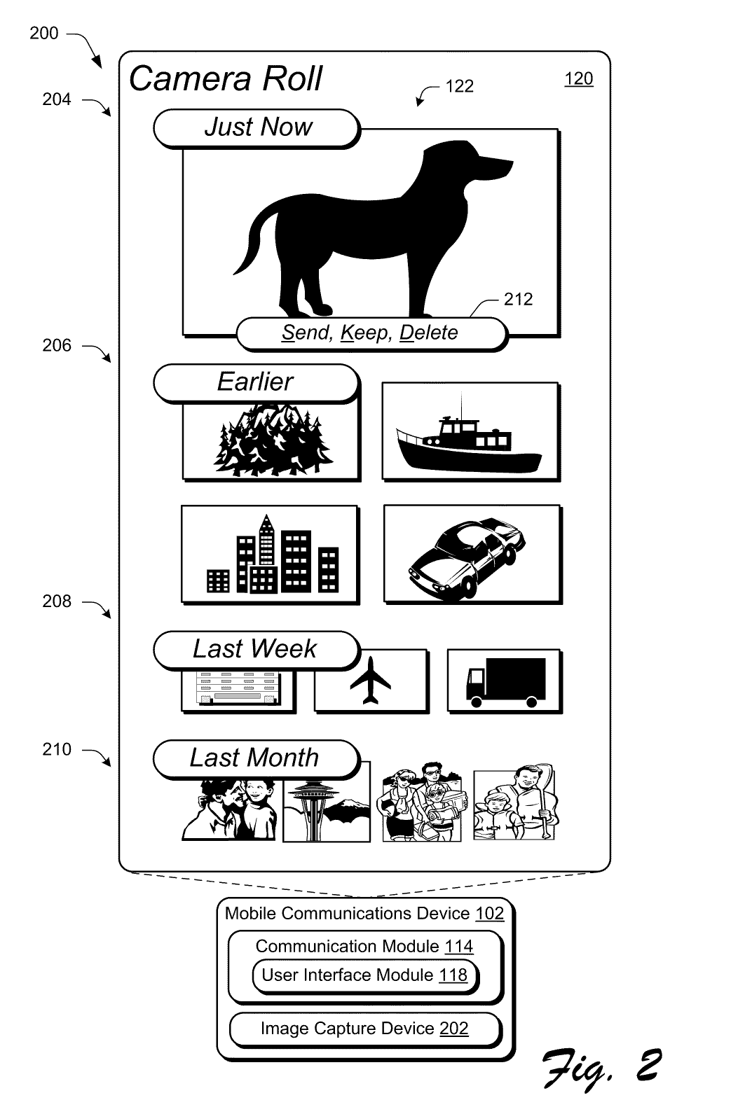

FIG. 2 illustrates a system 200 in an example implementation in which the mobile communications device 102 of FIG. 1 includes an image capture device 202 and outputs the user interface 120 as having a plurality of representations 122 of images. The image capture device 202 may be configured in a variety of ways to capture images and store them in storage 126 of the mobile communications device 102.

Representations 122 of those images (as well as others that may be communicated to the mobile communications device 102, such as via the network 116) are illustrated as output in the user interface 120 in groups. A first group 204 includes an identifier of “Just Now” that describes the content associated with that group. Identifiers are also included for second, third, and fourth groups 206, 208, 210 which are illustrated as having respective identifiers of “Earlier,” “Last Week,” and “Last Month.” This convention may continue for subsequent groups, such as to identify previous months before the “Last Month” by their respective names.

In this implementation, the respective first, second, third, and fourth groups 204, 206, 208, 210 correspond to different ranges of time as illustrated by the identifiers. Accordingly, the user interface module 118 may classify each item of the content 124 into a respective one of the groups. A display size may then be assigned to the representations of content based on the group to which the content is classified.

A representation that corresponds to the content in the first group 204 “Just Now,” for instance, may be assigned a relatively large display size, e.g., for an image that was most recently captured by the image capture device 202 of the mobile communications device 102. In the illustrated implementation, the first group 204 includes an “inline” menu 212 that includes actions that are performable using the content, examples of which include “Send,” “Keep,” and “Delete.” However, it should be readily apparent that a wide variety of other actions are also contemplated for inclusion based on the type of content represented in the user interface 120.

Representations of content that are classified in the second group 206 “Earlier” are assigned a slightly smaller display size than the representation in the first group 204 in this illustrated implementation. For example, the content in the second group 206 “Earlier” and the content for the first group 204 may have been captured in the same photo session and therefore have an increased likelihood of being of interest to a user that is capturing the images. Therefore, the user interface module 118 may assign display sizes to these representations such that a user may easily view the content captured during this session.

Content for the third and fourth groups 208, 210 that correspond to “Last Week” and “Last Month,” however, may have a decreased likelihood of being of interest to the user at this point in time. Therefore, the display area assigned to representations in the third group 208 is significantly less in this example than the second group 206. This convention continues in the illustrated example such that representations in the fourth group 210 have a lesser display size that the representations in the third group 208, and so on. In an implementation, the user interface 120 may be scrolled vertically (e.g., via a scroll gesture input via touchscreen functionality of the display device 110) to display additional representations of content 124. Although images were described in this example, these techniques may also be leveraged for a variety of other content, further discussion of which may be found in relation to the following figure.

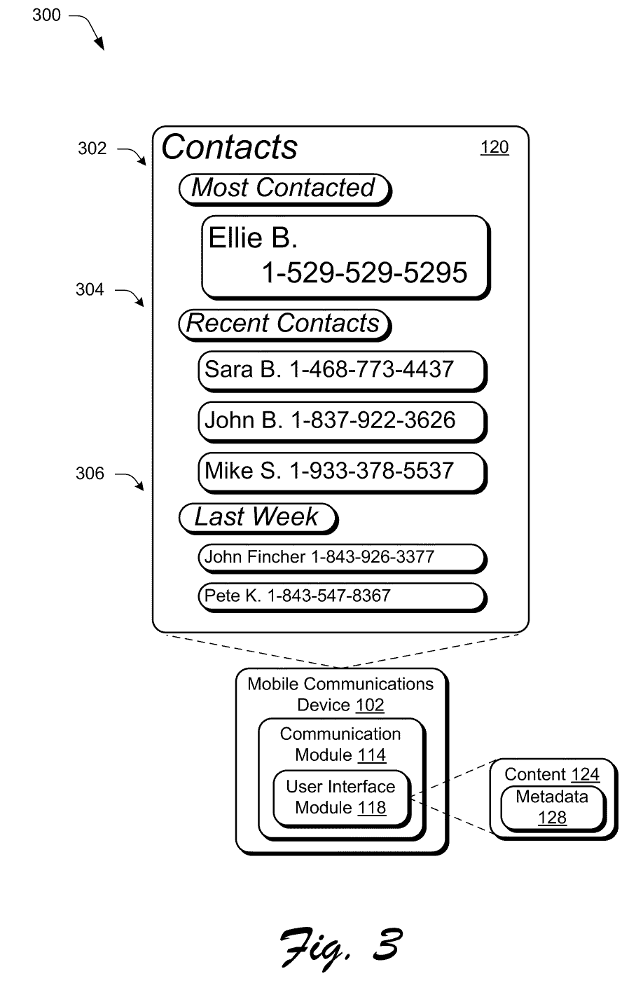

FIG. 3 illustrates an example system 300 in which the user interface 120 of FIG. 1 includes representations of contacts displayed using display size representation techniques. In this example, the first, second and third groups 302, 304, 306 include identifiers of “Most Contacted,” “Recent Contacts,” and “Last Week” in the user interface 120.

The user interface module 118 may leverage metadata 128 associated with the content 124 (e.g., contacts in this instance) in a variety of ways to classify the contacts in the groups. For example, for the first group 302 “Most Contacted” the user interface module 118 may make this determination based on which of the contacts was contacted the most.

However, for the second group 304 “Recent Contacts” the user interface module 118 may base this determination on which of the contacts we contacted most recently. Additionally, the user interface module 118 may remove the “most contacted” contact from this list (if included) so that it is not included more than one in the user interface 120 to conserve display area of the display device 120. Like before, display sizes may then be assigned according to group. In this way, different criteria may be used by the user interface module 118 to classify content into the different groups. Further discussion of the display size techniques may be found in relation to the following procedures.

Example Procedures

The following discussion describes user interface techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 and systems 200-300 of FIGS. 1-3, respectively.

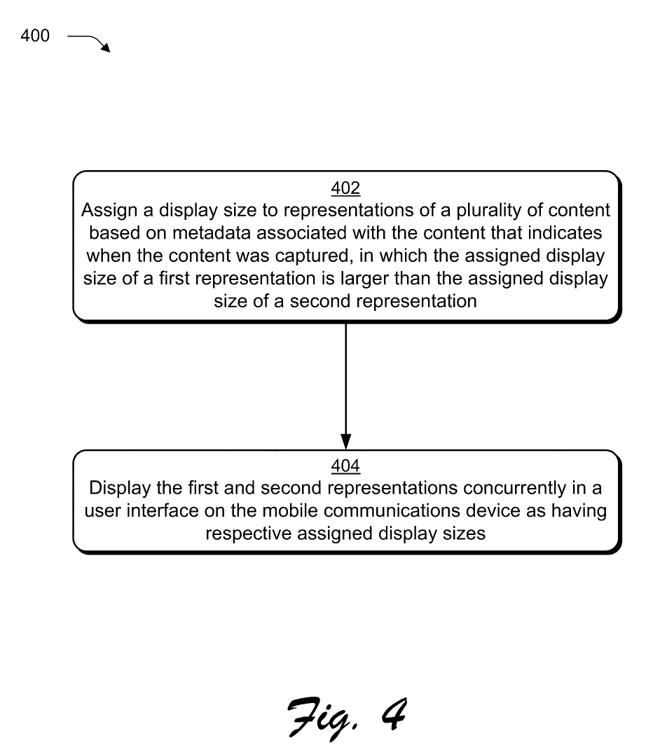

FIG. 4 depicts a procedure 400 in an example implementation in which representations are displayed as having a display size that is assigned according to when content that corresponds to the representations was captured. A display size is assigned to representations of a plurality of content based on metadata associated with the content that indicates when the content was captured, in which the assigned display size of a first representation is larger than the assigned display size of a second representation (block 402). For example, the content may correspond to images and therefore the display size may be assigned according to a data stamp included in the images that describes when the images were captured. A variety of other examples are also contemplated, such as voicemail (e.g., more recent voicemails are assigned a larger representation), music, and so on.

The first and second representations are displayed concurrently in a user interface on the mobile communications device as having respective assigned display sizes (block 404). For example, a representation of an image that was captured “Just Now” may be displayed larger than and at the same time as representations of images that were captured earlier (e.g., the second group 206), last week (e.g., the third group 208), and so on. The display size may be defined in a variety of ways, such as through an amount of display area of the display device 110 consumed, a number of representations that may be displayed in a given area of the display device 110, a font size of the representations (as compared one to another), and so on. Although display size based on when content was captured was described, the display size may be based on a variety of different criteria, further discussion of which may be found in relation to the following figure.

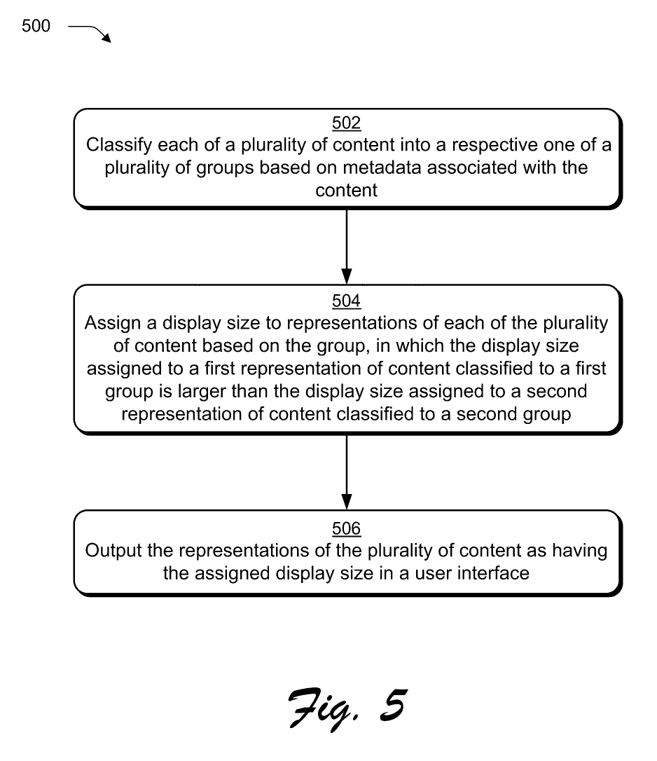

FIG. 5 depicts a procedure 500 in an example implementation in which content is classified into groups that serve as a basis for assigning a display size to representations of the content. Each of a plurality of content is classified into a respective one of a plurality of groups based on metadata associated with the content (block 502). For example, groups may be defined for different ranges of criteria (e.g., time) and different criteria may be used for each group. For instance, groups may be defined for different ranges of times, e.g., a first group may be defined for a most recent item of content (e.g., most recently captured), a second group may be defined for content that was taken within the week, and so on.

In another instance, groups may be defined based on different criteria, one to another, such as to reflect a likelihood that a user wishes to communicate with contacts in the groups. For instance, a first group may be defined for a most recent contact, e.g., a most recently sent communication (e.g., email, text, and so on) and therefore based on a temporal limitation. However, a second group may be defined for contacts with which communication was achieved within a defined period of time (e.g., with the last day, last week, and so on). Thus, criteria used to form the groups may be defined in a variety of different ways, e.g., use of different criteria and/or different combinations of criteria. Additionally, this criteria may be targeted towards the type of content to be represented, e.g., images, music, documents, spread sheets, voicemail messages, SMS, MMS, and so on.

A display size is assigned to representations of each of the plurality of content based on the group, in which the display size assigned to a first representation of content classified to a first group is larger than the display size assigned to a second representation of content classified to a second group (block 504). Continuing with the previous example, as previously described criteria used to define the groups may be targeted to reflect a likelihood that the user may wish to locate and interact with content in that group. Therefore, the display size may vary in accordance with this likelihood to assist a user in locating content of interest. For instance, a user may be more likely to wish to listen to recent voicemails than voicemails that were saved from last week. Accordingly, representations of recent voicemails may be assigned a greater display size than representations of voicemails from the previous week. A variety of other examples are also contemplated, such as for music (e.g., display size may vary with how recently the music was downloaded and/or frequency of playback), contacts, documents (e.g., how recently the documents were opened and/or frequency of interaction), and so on.

The representations of the plurality of content are output as having the assigned display size in a user interface (block 506). The mobile communications device 102, for instance, may display the representations in the user interface 120 to consume an amount of display area of the display device 110 as calculated in the previous block. The display size may be assigned a variety of ways, such as a percentage to be applied to a baseline size, through defined sizes specified for each group, and so on.

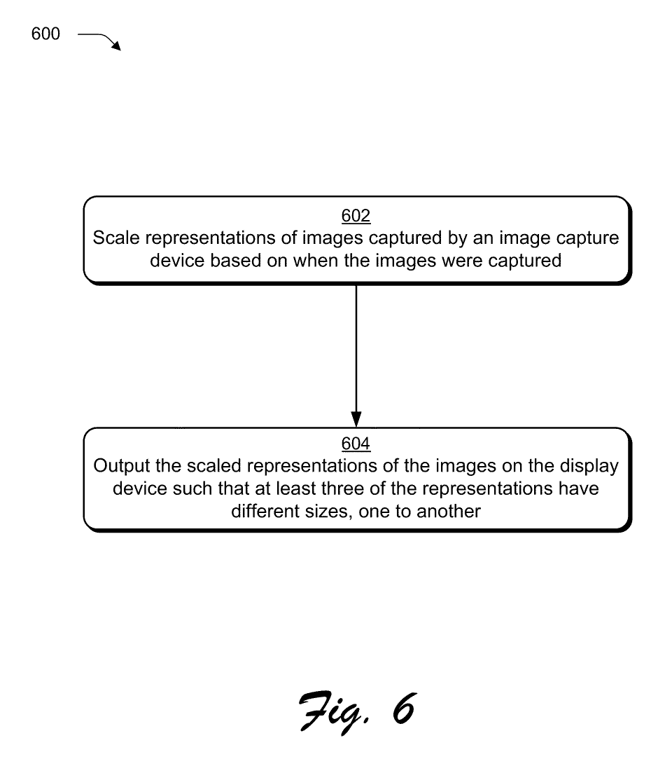

FIG. 6 depicts a procedure 600 in an example implementation in which representations of images captured by a mobile communications device are scaled based on when the images were captured. Representations of images captured by an image capture device are scaled based on when the images were captured (block 602). For example, representations (e.g., thumbnails) may be assigned display sizes on a sliding scale based on when respective images were captured, e.g., from most recent and then decrease proportionally in size. Therefore, in this example the display size varies directly and proportionately with values of the one or more criteria used to determine the display size. In another example, representations may be assigned based on a classification into a group such that inclusion in the group is used to assign the display size. A variety of other examples are also contemplated.

The scaled representations of the images are output on the display device such that at least three of the representations have different sizes, one to another (block 604). As shown in FIG. 2, for instance, representations included in the first, second, and third groups 204, 206, 208 have different display sizes, one to another. Likewise, as shown in FIG. 3, representations included in the first, second, and third groups 302, 304, 306 also have different display sizes, one to another. As described in relation to the previous figures, the display sizes may be defined in a variety of ways, such as an amount of display area of the display device 110 consumed by the respective representation.

Example Device

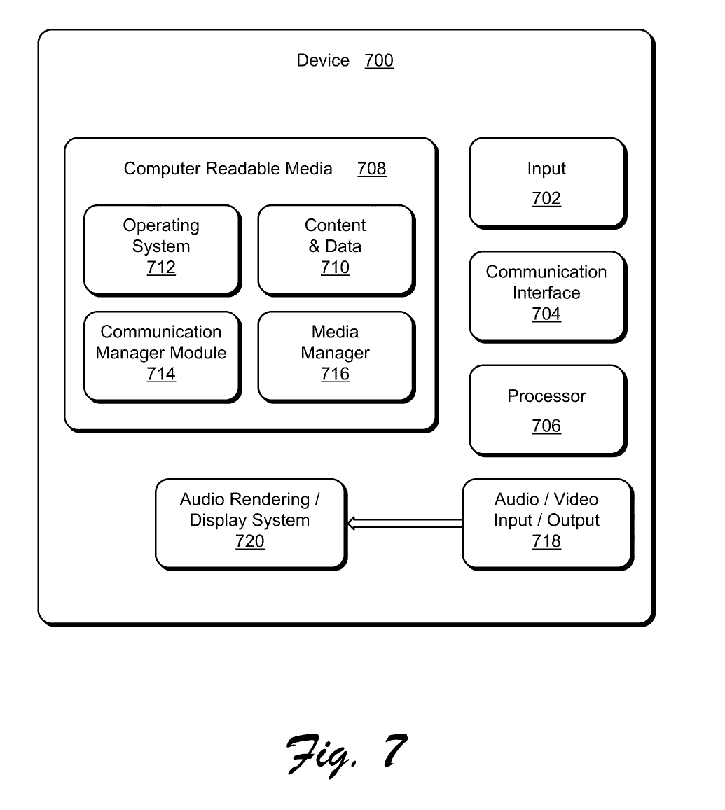

FIG. 7 illustrates various components of an example device 700 that can be implemented in various embodiments as any type of a mobile device to implement embodiments of devices, features, and systems for mobile communications. For example, device 700 can be implemented as any of the mobile communications devices 72 described with reference to respective FIGS. 1-3. Device 700 can also be implemented to access a network-based service, such as a social network service.

Device 700 includes an input 702 that may include Internet Protocol (IP) inputs as well as other input devices, such as the keyboard 112 of FIG. 1. Device 700 further includes a communication interface 704 that can be implemented as any one or more of a wireless interface, any type of network interface, and as any other type of communication interface. A network interface provides a connection between device 700 and a communication network by which other electronic and computing devices can communicate data with device 700. A wireless interface enables device 700 to operate as a mobile device for wireless communications.

Device 700 also includes one or more processors 706 (e.g., any of microprocessors, controllers, and the like) which process various computer-executable instructions to control the operation of device 700 and to communicate with other electronic devices. Device 700 can be implemented with computer-readable media 708, such as one or more memory components, examples of which include random access memory (RAM) and non-volatile memory (e.g., any one or more of a read-only memory (ROM), flash memory, EPROM, EEPROM, etc.).

Computer-readable media 708 provides data storage to store content and data 710, as well as device applications and any other types of information and/or data related to operational aspects of device 700. For example, an operating system 712 can be maintained as a computer application with the computer-readable media 708 and executed on processor 706. Device applications can also include a communication manager module 714 (which may be used to provide telephone functionality) and a media manager 716.

Device 700 also includes an audio and/or video output 718 that provides audio and/or video data to an audio rendering and/or display system 720. The audio rendering and/or display system 720 can be implemented as integrated component(s) of the example device 700, and can include any components that process, display, and/or otherwise render audio, video, and image data. Device 700 can also be implemented to provide a user tactile feedback, such as vibrate and haptics.

Generally, the blocks may be representative of modules that are configured to provide represented functionality. Further, any of the functions described herein can be implemented using software, firmware, hardware (e.g., fixed logic circuitry), or a combination of these implementations. The terms “module,” “functionality,” and “logic” as used herein generally represent software, firmware, hardware or a combination thereof. In the case of a software implementation, the module, functionality, or logic represents program code that performs specified tasks when executed on a processor (e.g., CPU or CPUs). The program code can be stored in one or more computer readable memory devices. The features of the techniques described above are platform-independent, meaning that the techniques may be implemented on a variety of commercial computing platforms having a variety of processors.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method performed by a mobile communications device, the method comprising:
assigning a display size to representations of a plurality of content based on metadata associated with the content that indicates when the content was captured, in which the assigned display size of a first said representation is larger than the assigned display size of a second said representation; and
displaying the first and second said representations concurrently in a user interface on the mobile communications device as having respective said assigned display sizes.

2. A method as described in claim 1, wherein the content that corresponds to the first said representation was captured more recently than the content that corresponds to the second said representation.

3. A method as described in claim 1, wherein the displaying includes a concurrent display of a third said representation such that the display size of the first, second, and third representations is different, one to another.

4. A method as described in claim 1, wherein the content includes at least one image captured by the mobile communications device.

5. A method as described in claim 1, wherein the content that corresponds to the first said representation is an image that was most recently captured by the mobile communications device.

6. A method as described in claim 1, wherein:
the displaying is performed such that the first said representation is displayed in a first group and the second said representation is displayed in a second group; and
the first and second groups are defined for different ranges of time.

7. A method as described in claim 6, wherein the first and second groups are displayed in conjunction with an identifier that describes the respective group.

8. A method as described in claim 1, wherein the first said representation of content is displayed concurrently with a menu of actions that involve the content.

9. One or more computer-readable storage media comprising instructions that are executable by a computer to:
classify each of a plurality of content into a respective one of a plurality of groups based on metadata associated with the content;
assign a display size to representations of each of the plurality of content based on the group in which the display size assigned to a first said representation of content classified to a first said group is larger than the display size assigned to a second said representation of content classified to a second said group; and
output the representations of the plurality of content as having the assigned display size in a user interface.

10. One or more computer-readable storage media as described in claim 9, wherein the display size assigned to the first said representation of content is larger than the display size assigned to a second said representation such that an amount of display area of a display device of the computer that is used to display the first said representation is greater than an amount of display area of the display device that is used to display the second said representation.

11. One or more computer-readable storage media as described in claim 9, wherein the representations are icons that are selectable to cause output of respective said content.

12. One or more computer-readable storage media as described in claim 9, wherein the output of the representations of the plurality of content is performed to include an identifier of a respective said group.

13. One or more computer-readable storage media as described in claim 9, wherein the classification is performed based on a temporal indication included in the metadata.

14. One or more computer-readable storage media as described in claim 9, wherein the metadata describes interaction with respective said content.

15. One or more computer-readable storage media as described in claim 14, wherein the metadata describes a number of times respective said content was output.

16. One or more computer-readable storage media as described in claim 9, wherein the computer is a mobile communications device.

17. A mobile communications device comprising:
a display device;
an image capture device; and
one or more modules to scale representations of images captured by the image capture device based on when the images were captured and output the scaled representations of the images on the display device such that at least three of the representations have different sizes, one to another.

18. A mobile communications device as described in claim 17, wherein the one or more modules are further configured to include telephone functionality to communicate one or more of the plurality of images to another mobile communications device.

19. A mobile communications device as described in claim 17, wherein:
the one or more modules are further configured to scale the representations based on which of a plurality of groups corresponding said content belongs; and
each said group defines a period of time.

20. A mobile communications device as described in claim 19, wherein each said group is output in the user interface as having an identifier that describes the period of time.
